(19) United States
(12) Patent Application Publication
(10) Pub. No.: US 2012/0090418 A1
(43) Pub. Date: Apr. 19, 2012

(54) BALL SCREW WITH CIRCUMFERENTIAL STOP

(75) Inventors: Stefanie Barthlein, Baudenbach (DE); Manfred Kraus, Herzogenaurach (DE); Josef Miko, Emskirchen (DE); Jurgen Osterlanger, Emskirchen (DE)

(73) Assignee: SCHAEFFLER TECHNOLOGIES GMBH & CO. KG, Herzogenaurach (DE)

(21) Appl. No.: 13/377,333

(22) PCT Filed: Jul. 19, 2010
(86) PCT No.: PCT/EP10/60445

§ 371 Date: Dec. 9, 2011

(30) Foreign Application Priority Data
Aug. 10, 2009 (DE) 102009036886.8

(51) Int. Cl. F16H 25/22

(52) U.S. Cl. 74/424.81

(57) ABSTRACT

A ball screw (7, 24), having a threaded nut (10, 26) which is arranged on a threaded spindle (8, 28) and having a stop (43) for the circumferential abutment of the threaded nut (10, 26) in its stop position provided on the threaded spindle (8, 28), wherein the stop (43) has a first stop surface (47) assigned to the threaded nut (10, 26) and has a second stop surface (48) which is provided for abutting against the first stop surface (47) and which is assigned to the threaded spindle (8, 28), and, in the stop position, an axial overlap of the first stop surface (47) with the second stop surface (48) is provided, which overlap amounts to between 20% and 85% of the pitch of the threaded spindle (8, 28).

### FIELD OF THE INVENTION

The present invention relates to a ball screw. Ball screws convert rotational movements into translatory movements. The present invention also relates in particular to an actuating device for actuating a brake, in particular parking brake for a motor vehicle, having such a ball screw.

### BACKGROUND

EP 1058795 B1, for example, discloses an actuating device for a parking brake of a motor vehicle, in which actuating device a ball screw is provided.

The threaded spindle, which is driven by an electric motor, effects a relative axial displacement between the threaded nut and the threaded spindle, wherein the threaded nut, in its feed direction, exerts a pressure force on a friction pad of a disk brake via further machine parts. To release the parking brake, the threaded spindle is driven in the opposite rotational direction; the threaded nut travels back on the threaded spindle until it reaches a stop position in which a stop takes effect. The circumferential stop takes effect before the threaded nut can be axially braced with a stop part which is arranged on the threaded spindle and which has the projection.

In the ball screw application described here, a circumferential stop of said type is important for correct functioning of the ball screw. Without a circumferential stop of said type, it would undesirably be possible for the threaded nut to be axially braced in the manner of a tightened screw nut, and a release of said axial bracing action would be possible only by imparting a considerable torque.

In said known ball screw, the projections provided on the threaded nut and on the stop part have a first stop surface and have a second stop surface which is provided for abutting against the first stop surface. Before the final possible rotation between the threaded nut and the stop part, there must still be an axial spacing between the two projections sufficient to prevent these from abutting against one another at the end side. During the final rotation, the two projections overlap one another in the axial direction; the two projections finally circumferentially abut against one another with their stop surfaces, and a further relative rotation between the threaded spindle and the threaded nut is prevented. The interaction of the two stop surfaces is important for correct abutment.

### SUMMARY

It was an object of the present invention to specify a ball screw according to the features of the invention, in which correct abutment is ensured.

According to the invention, this object is achieved by the ball screw according to the invention. Correct functioning of the stop is ensured in that, in the stop position, an axial overlap of the first stop surface with the second stop surface is provided, which overlap amounts to between 20% and 85% of the pitch of the threaded spindle (8, 28).

The stop position is attained according to the invention when the two stop surfaces abut against one another, and a further relative rotation is accordingly prevented.

The axial overlap in the axial direction may theoretically be at most as large as the pitch of the threaded spindle. Within the context of the present invention, the pitch is to be understood as the distance covered in the axial direction between the threaded nut and threaded spindle when one full relative rotation between the threaded nut and the threaded spindle takes place.

In the case of a large pitch of the threaded spindle, a large axial overlap in terms of magnitude can be obtained. If torques of approximately 50 Nm are transmitted via the stop surfaces, an adequately large axial overlap which permits an adequate contact pressure must be selected. In this case, the axial overlap thus determined may, in the case of large pitches, lie more toward the lower value according to the invention.

In the case of a small pitch of the threaded spindle, there is accordingly a small axial overlap in terms of magnitude. In this case, the value set according to the invention will lie more toward the upper value according to the invention in order to permit an adequate axial overlap for example with regard to the contact pressure.

The axial overlap may be specified as the portion over which the first and second stop surfaces overlap one another in the axial direction.

During the manufacture of the stop surfaces, the contours thereof are provided, for manufacturing reasons, with roundings in particular at edges of said stop surfaces, in particular if said contours are formed in a deformation process. This means that, if for example an overlap of for example 1 mm were measured between the two stop surfaces in the axial direction, it would be necessary to take into consideration that, on account of roundings of the contours at the edges and on account of tolerances, there would only be an effective overlap of 0.5 mm available for the transmission of a torque via the stop surfaces. The invention has recognized that, in the selected range, in particular in the case of parking brakes having ball screws according to the invention, reliable operation of the stop is ensured without an unnecessarily large amount of axial installation space being taken up. If the overlap amounts, according to the invention, to between 20% and 85% of the pitch, an effective overlap of between 15% and 50% of the pitch of the threaded spindle is obtained even in the case of large tolerances and roundings.

The axial overlap which is possible from the aspect of the dimensioning of the stop surfaces may be larger than the effective overlap, but at most as large as the pitch of the threaded spindle. The effective overlap takes into consideration that roundings which are not available for transmitting a torque may be formed at the edges of the stop surfaces.

In the case of a gradient of the threaded spindle of 3.6 mm and an axial overlap of for example 1.8 mm, there may, owing to roundings of the edges of the first stop surface and the projection, be a reduced effective overlap of 1.2 mm, which corresponds to a fraction of approximately 33% of the pitch of the threaded spindle.

In the case of ball screws according to the invention as actuating devices for parking brakes, a pitch of between 3 mm and 4 mm is expedient. In the case of very small pitches, it is duly possible for large axial feed forces to be generated; however, the axial overlap is then likewise very small because the axial overlap cannot be larger than the pitch.

In a refinement according to the invention, the second stop surface may be formed on an axial projection of a stop part arranged on the threaded spindle. When the spindle nut is in its stop position, it is provided according to the invention that there is a minimum spacing between the end sides, which face toward one another, of the stop part and of the threaded nut, such that axial bracing of the threaded nut is in any case prevented. Said minimum spacing should lie between 3/10 mm and 1 mm.

The threaded nut may be provided, on its end side facing toward the stop part, with a recess which is open at the end side, which recess is delimited circumferentially by the first stop surface.

The stop part may be formed by a support disk which is arranged on the threaded spindle to transmit a torque and which is provided with the projection. In the stop position, the projection protrudes into the recess formed on the end side of the threaded nut, and in the stop position, bears against the first stop surface which circumferentially delimits the recess. In said stop position, the minimum spacing is provided between the end sides of the threaded nut and the support disk.

When the stop takes effect, and the stop surfaces abut against one another, it is possible in the case of the parking brake application for a torque of approximately 50 Nm to be transmitted. To minimize the bending moments acting on the projection on account of the torque, one refinement according to the invention provides that the axial extent of the projection is formed so as to be at most as large as the pitch of the threaded spindle. The axial extent may, in the example of the support disk, be measured from the end side of the support disk to the free end of the projection.

The axial projection which is preferably integrally formed on the support disk is provided, on its side facing toward the first stop surface, with a second stop surface which abuts against the first stop surface; in the stop position, the two stop surfaces lie preferably in a common plane with the spindle axis. It is ensured in this way that no radial forces are transmitted via the stop surfaces. Said common plane for the stop surfaces and the spindle axis may be independent of the design of the stop part or of the threaded nut.

What is essential is the common plane, because forces transmitted in said plane act only in the circumferential direction, but not radially.

It has already been stated that the engagement of the projection into the recess becomes progressively more pronounced with a relative rotation between the threaded nut and projection, specifically in accordance with the pitch of the threaded spindle. In one refinement according to the invention, it is provided that the recess extends in the circumferential direction at least over an angle formed from a quotient of the ratio of the actual axial overlap to the pitch of the threaded spindle, multiplied by 360 degrees, wherein the axial overlap and the pitch of the threaded spindle are both designated using the same unit of length.

The greater the axial overlap, the larger the angle. If a large axial overlap is sought in order to obtain greater reliability during the transmission of torque, it is possible, by the dimensioning rule according to the invention, for a correspondingly large angle to be provided. Said angle is available for a protrusion of the projection during a relative rotation between the threaded nut and stop part. Said angle may therefore be referred to as the protrusion angle, which should preferably be at least 180 degrees. With said protrusion angle, an adequate axial overlap can be ensured even with threaded spindles of different pitch. The larger said protrusion angle, the greater the axial overlap that can be obtained.

### BRIEF DESCRIPTION OF THE DRAWINGS

Two exemplary embodiments of the invention are illustrated in the drawing and will be described in more detail below. In the drawing:

FIG. 1 shows a diagrammatic, sectional illustration of a brake device having a ball screw according to the invention in the unloaded state,

FIG. 2 shows an enlarged detail view of the region II from FIG. 1,

FIG. 3 shows an enlarged detail view of the region III from FIG. 1, and

FIG. 4 shows the brake device from FIG. 1 in the loaded state with elements tilted relative to one another,

FIG. 5 shows, in section, a further brake device having a ball screw according to the invention,

FIG. 6 shows the ball screw from FIG. 5, and

FIG. 7 shows an enlarged detail from FIG. 6,

FIG. 8 shows individual parts of the ball screw from FIG. 6,

FIG. 9 shows a further individual part of the ball screw from FIG. 6,

FIG. 10 shows the ball screw according to the invention in a partially cut-away illustration, and

FIG. 11 shows the ball screw according to the invention from FIG. 10 in cross section along the section line XI-XI.

### DETAILED DESCRIPTION OF THE PREFERRED EMBODIMENTS

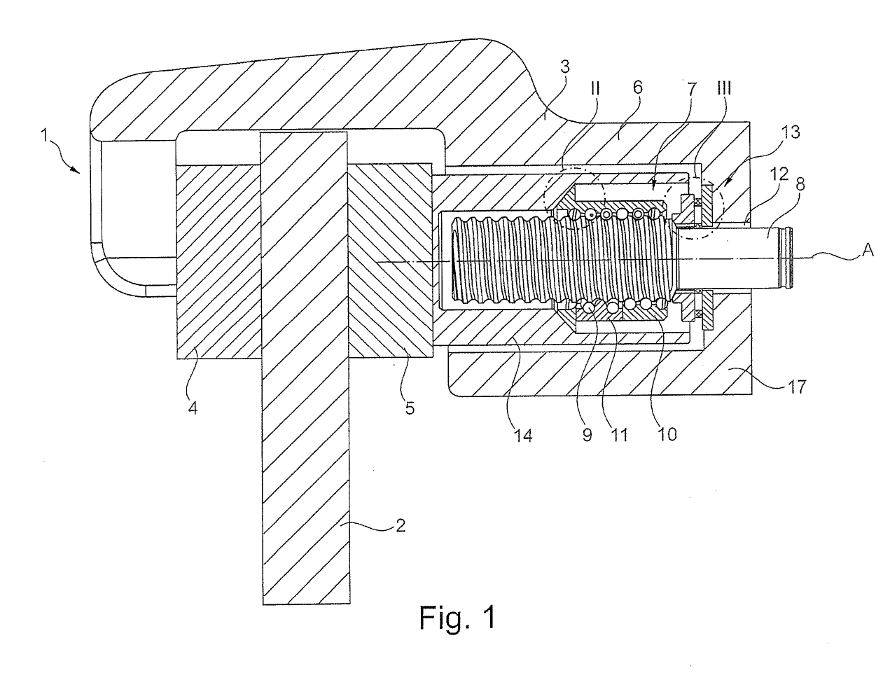

FIG. 1 shows a brake device 1 according to the invention of the type which may be implemented as a parking brake or immobilizing brake in a motor vehicle, for example. The brake device 1 comprises a brake disk 2, which is connected in a known way to the wheel, and a brake caliper 3 of substantially C-shaped cross section, which fits over the brake disk 2. Accommodated in said brake caliper are two brake pads 4, 5, which are positioned on both sides of the brake disk 2 arranged between them and, for the purpose of braking, bear firmly against the latter, clamping the brake disk between them. FIG. 1 shows the release position, that is to say when the brake disk 2 is not clamped and the brake disk 2 can rotate freely between the two brake pads 4, 5, even though these are resting directly against the brake disk for the sake of the illustration. In actual fact, there is a minimal gap between the brake disk 2 and the brake pads 4, 5, allowing free rotation in the release position.

FIG. 1 furthermore shows a ball screw 7 according to the invention, which is accommodated in a portion 6 of the brake caliper 3 that may be formed in the manner of a housing and which comprises a threaded spindle 8, on which a threaded nut 10 runs in a manner guided by balls 9, the balls 9 circulating continuously and being constantly returned by means of at least one ball return element 11. The spindle 8 is connected to a drive motor (not shown in any more detail here), which is preferably arranged in the region of the outside of the housing-like portion 6 and the output shaft of which is at an angle of 90°, for example, to the threaded spindle 8. The output shaft of said drive motor is coupled to the threaded spindle 8 by way of a cardan joint, which allows the threaded spindle 8 to be motor-driven. The threaded spindle 8 is furthermore rotatably mounted in a fixed position on the brake caliper 3 by means of a radial bearing 12 and an axial bearing 13, in the present case in the form of a needle-roller bearing.

The threaded nut 10, for its part, is coupled to a piston 14, and the said piston rests on the front end edge of the threaded nut 10, that is to say is supported there. The movable brake pad 5 is arranged on the piston 14. If the drive motor (not shown in any more detail) is now activated, by actuation of a suitable actuating element on the vehicle, in order to actuate the brake device and hence to fix the brake disk 2, the threaded spindle 8 is moved by the drive motor and rotates, with the result that the threaded nut 10 travels along the threaded spindle 8, being guided by the balls 9 in the process, that is to say moves to the left in FIG. 1. During this process, the piston 14 seated on the end face of the threaded nut 10, and together with it the brake pad 5, is pushed to the left, with the result that it is brought firmly into contact with the brake disk, which is supported against the other brake pad 4, whereby the said brake disk is fixed between the two brake pads 4, 5.

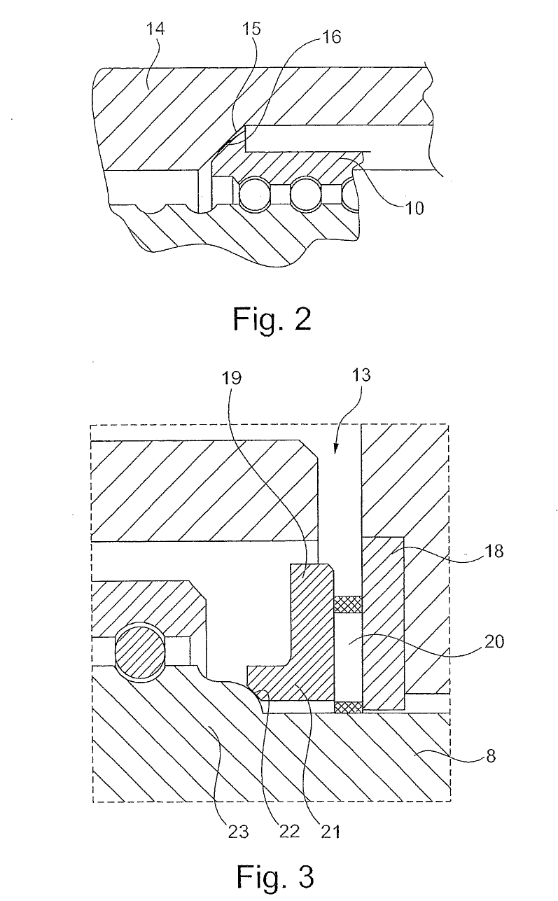

FIG. 2 shows on an enlarged scale a detail view of the seating region of the piston 14 on the threaded nut 10. The piston 14 has a conical guide surface 15, opposite which is a second guide surface 16 on the end of the threaded nut 10, the said second guide surface likewise being conical in terms of its basic shape but having a crowned or convex external form. This means that there is no extensive contact here but only linear bearing of guide surface 15 on guide surface 16. The effect is that the piston 14 is seated in a movable fashion on the nut 10, that is to say guide surface 15 can move on guide surface 16 owing to the linear support. The piston 14 can therefore tilt relative to the threaded nut 10 and a movable bearing arrangement is achieved, with lubrication by means of a suitable lubricant to reduce friction.

As FIG. 3 shows in an enlarged detail view, a bearing arrangement which is likewise movable is achieved in the region of support of the threaded spindle 8 on the brake caliper 3. As explained, the threaded spindle 8 is supported on the wall 17 of the brake caliper, on the one hand radially by means of the radial bearing 12 and, on the other hand, by means of the axial bearing 13. This axial bearing comprises a first bearing disk 18 (housing disk), which is arranged in a fixed position on the wall 17, and a second bearing disk 19 (shaft disk), which runs on the first bearing disk 18 by way of needle rolling bodies 20. Bearing disk 19 has an axial projection 21, which has a conical second bearing surface 22 that, like guide surface 16 in the arrangement for supporting the piston 14 on the threaded nut 10, has a crowned convex surface with a basic shape that is preferably substantially conical.

The threaded spindle 8, for its part, has a first, convex bearing surface 23. It is therefore evident in this case also that a movable bearing arrangement is achieved since, here too, the first bearing surface 23 rests on the second bearing surface 22 only along a line but not over an area. The effect is that the threaded spindle 8 can tilt slightly relative to the positionally fixed axial bearing 13, specifically relative to the positionally fixed bearing disk 19, lubrication likewise being provided. This tilting is made possible by the fact that the threaded spindle 8 is likewise accommodated with a certain play in the radial bearing 12, or the radial bearing, a plastic plain bearing for example, allows a certain tilting. During operation, when the caliper expands owing to the forces that are acting, the tilt angle is in a range of significantly<0.5° per movable bearing location and, as a result, the plain bearing 12 is not subjected to significant loads.

Of course, it is possible with both bearing locations to implement the crowning on the respective other guide surface or to make both guide surfaces crowned.

Thus, in the brake device 1 according to the invention, two movable bearing locations are implemented, namely in the region of the seating of the piston 14 on the nut 10 on the one hand, and in the region of the seating of the threaded spindle 8 on the axial bearing 13 on the other hand. The effect is then that tilting of the relevant axes, which is present in known brake devices and results in high bearing loads that can lead to premature bearing failure, can be compensated to a large extent, thus making it possible to significantly reduce bearing loads.

In the unloaded position shown in FIG. 1, the three longitudinal axes of the threaded spindle 8, the brake caliper 3 or, more specifically, the preferably cylindrical housing-like portion 6, and the piston 14 coincide and are denoted in this Figure as a common axis with the letter A.

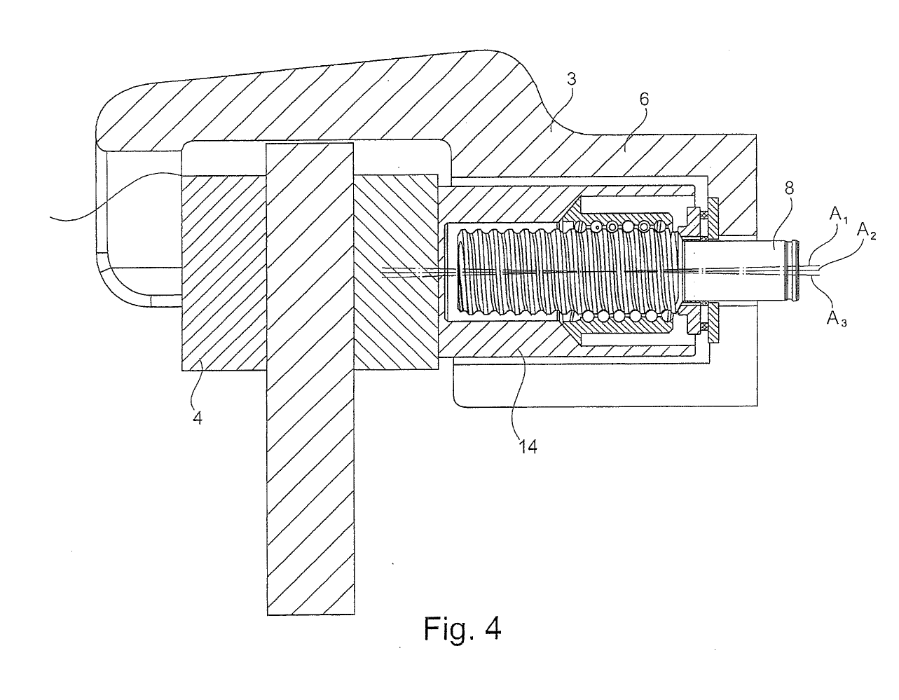

If the motor (not shown) is now used to activate the threaded spindle 8 and, by means of the latter, the piston 14 and with it the brake pad 5 is pressed against the brake disk 2, the brake caliper 3 is expanded or spread apart to a greater or lesser extent, depending on the contact force, as shown in FIG. 4. As can be seen, the brake caliper 3 expands and, on the one hand, a slight gap 24 is formed in the region of brake caliper contact with the first brake pad 4, and, as can also clearly be seen, portion 6 of the brake caliper 3 adopts an angled position relative to the piston 14. At this point, it should be pointed out that FIG. 4 shows a significantly exaggerated expansion and tilting of components compared with that which occurs in reality, this being for the sake of illustration.

By virtue of the two separate instances of mobility or movable bearing arrangements that are implemented, however, this severe angular offset can be effectively split up and the load acting on the axial bearing can be significantly reduced. This is because, on the one hand, the tilting of the brake caliper 3, that is to say its spreading apart, has the effect that the piston 14 tilts slightly relative to the nut 10, this being obtained by means of the movable seating of the piston 14 on the nut 10 via the guide surfaces 15, 16, as shown in detail in FIG. 2. In the same way, there is slight tilting of the seating of the threaded spindle 8 on the axial bearing 13 or bearing disk 19 by virtue of the movable bearing arrangement implemented there, as shown in FIG. 3. Here too, there is therefore an albeit slight relative movement or tilting movement. That is to say that the piston 14, the threaded nut 10, the threaded spindle 8, and the axial bearing 13 or bearing disk 19 consequently adjust relative to one another in pairs under the effect of load and consequently there is splitting and hence, at the same time, a local reduction of the individual tilt angles. The movement of the axial bearing 13 relative to the threaded spindle 8 also has the effect that the threaded spindle 8 moves or tilts relative to the radial bearing 12, as is likewise illustrated in FIG. 4. While all the longitudinal axes coincide in FIG. 1 as described, there is now an axial offset owing to the expansion of the brake caliper, but this is significantly less owing to the instances of mobility achieved than it would be with a rigid bearing arrangement. As can be seen, the individual axes A₁ of the brake caliper 3, A₂ of the ball screw 7 or threaded spindle 8, and A₃ of the piston 14 no longer coincide, but the respective axial offset is nevertheless relatively small. The maximum skewing or tilting of about 0.5° of the brake caliper axis relative to the normal to the brake disk which occurs in actual operating conditions can be well compensated by the decoupling of the elements which is provided for by the invention, that is to say by their mobility relative to one another, with the result that, overall, either the ball screw can be constructed with somewhat smaller dimensions and/or the service life of the bearings increases significantly.

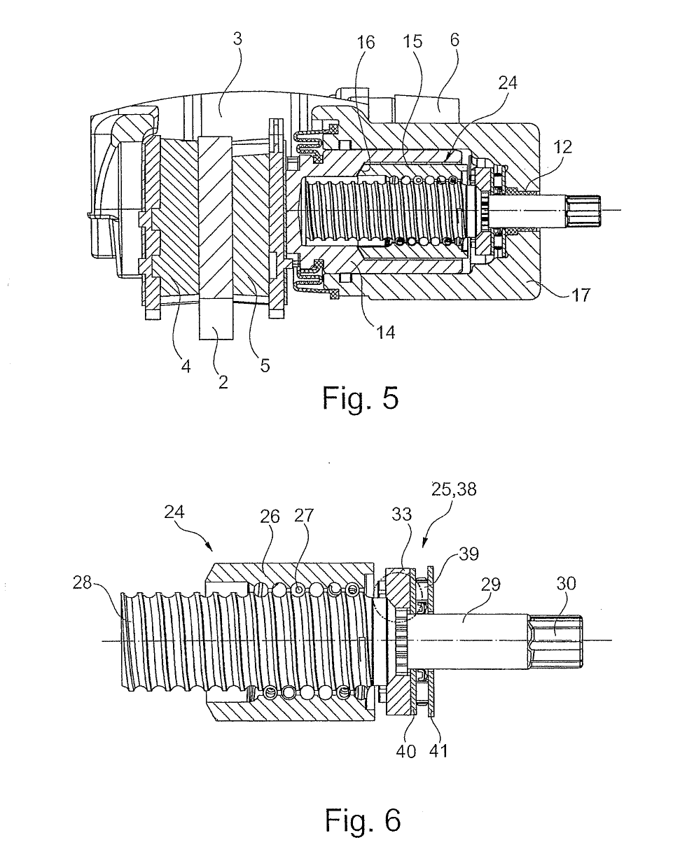

FIGS. 5 to 11 show a further brake device having a ball screw 24 according to the invention. In this arrangement, the invention may also be referred to as an actuating device for a parking brake.

Where components illustrated here correspond to those of the exemplary embodiment described above, the same reference numerals are used.

FIG. 5 shows, in section, a parking brake or immobilizing brake having the ball screw 24 according to the invention. Here, an axial bearing 25 is provided which is modified in relation to the preceding exemplary embodiment.

The ball screw 24 according to the invention with the axial bearing 25 is shown clearly in section in FIG. 6. A threaded nut 26 is mounted in a rolling fashion on a threaded spindle 28 in a known way by means of balls 27. The threaded spindle 28 has, outside its portion which interacts with the threaded nut 26, a radially stepped spindle portion 29 which is provided, on the axial end thereof, with a polygon 30. A gearing (not shown here) may be connected at the drive output side to said polygon 30.

FIG. 6 also shows that the threaded spindle 28 is guided with its spindle portion 29 through the axial bearing 25. The axial bearing 25 comprises a support disk 33 and an axial rolling bearing 38 in which rollers 39 are arranged between two bearing disks 40, 41. One bearing disk 40 bears against the support disk 33, and the other bearing disk 41 is supported against the housing-side portion 6.

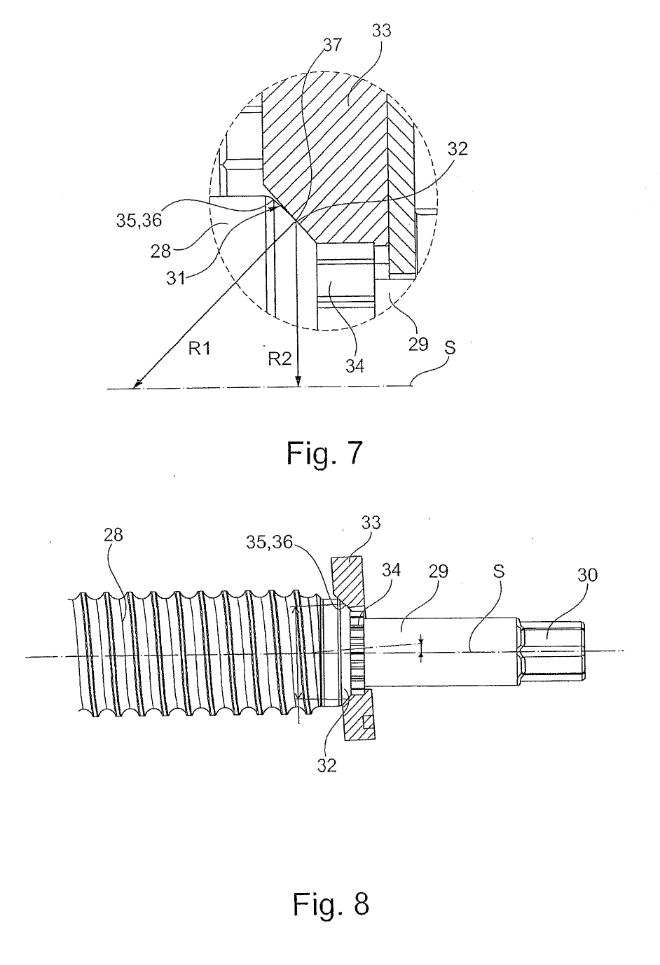

FIG. 7 shows an enlarged detail of the ball screw 24 and of the axial bearing 25. The threaded spindle 28 is provided with a shoulder 31 at the transition to the radially recessed spindle portion 29. Said shoulder 31 has a bearing surface 32 which is convexly shaped with a radius of curvature. A support disk 33 of the axial bearing 25 is arranged on the threaded spindle 28 for conjoint rotation therewith, but such that it can perform a wobbling motion, via a toothing 34. The support disk 33 is provided, on its end side facing toward the first bearing surface 32, with a conical opening 35 which forms a second bearing surface 36.

The spindle axis S is indicated in FIG. 7. The radius of curvature R1 of the first bearing surface 32 intersects the spindle axis S. The two bearing surfaces 32, 36 make contact with one another along an annular contact path 37, the central point of which likewise lies on the spindle axis S. Said annular contact path 37 has a radius R2. It can be seen from FIG. 7 that the two radii R1 and R2 are arranged spaced apart from one another on the spindle axis S. The radius R1 is larger than the radius R2, wherein according to the invention, a quotient formed from the ratio of the radius R1 to the radius R2 assumes values between 1.4 and 1.6 inclusive. A circle drawn with the radius of curvature R1 lies in the plane of the page. A circle drawn with the radius of curvature R2 lies in a plane arranged perpendicular to the plane of the page.

FIG. 8 shows the situation in which, owing to an elastic deformation of the brake caliper 3 or of the housing-like portion 6, the support disk 33 is tilted relative to the threaded spindle in 28 by approximately 0.5°, wherein in the illustration, said tilt is illustrated on an exaggerated scale. Undesired loading of the axial bearing 25 with a bending moment is accordingly prevented. The support disk 33 is accordingly arranged on the threaded spindle 28 so as to be capable of performing a wobbling motion; said support disk can tilt about axes perpendicular to the spindle axis, and can transfer torques for the transmission of torques between support disk 33 and threaded spindle 28.

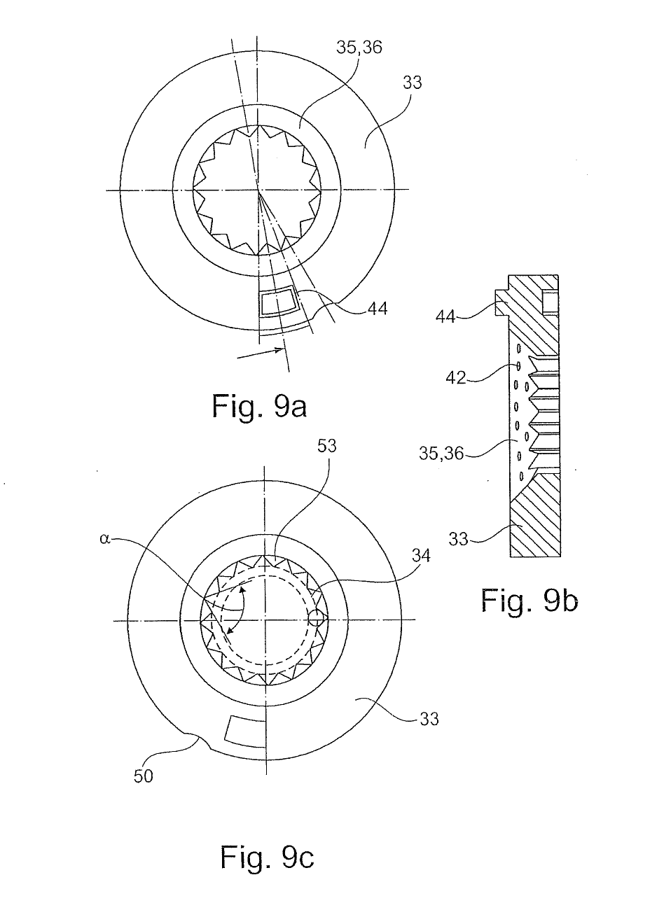

FIGS. 9a, 9b, 9c show the support disk 33 in two views and in longitudinal section. In FIG. 9b, pockets 42 for receiving lubricant are provided in the wall of the conical opening 35. A lubricating film is thus built up in the contact path 37, which lubricating film promotes free-moving tilting of the two bearing surfaces 32, 36.

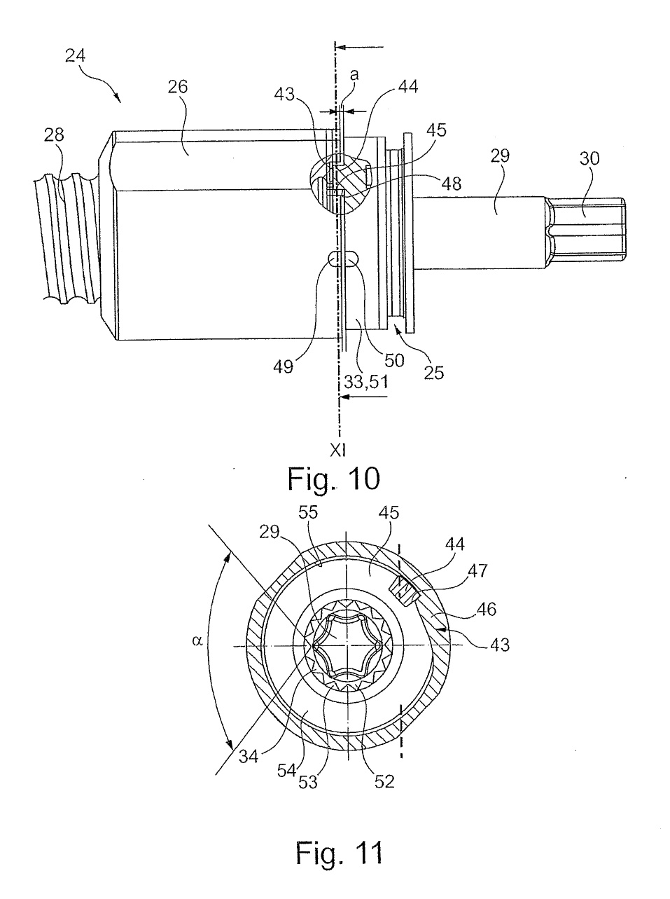

FIG. 10 shows the ball screw according to the invention, with threaded nut 26 and support disk 33 illustrated in partially cut-away form. Here, it is possible to see a circumferential stop 43 for the threaded nut 26, which stop will be described in more detail below.

It can be seen from FIG. 10 that the support disk 33 is provided, on its end side facing toward the threaded nut 26, with an axial projection 44. Said axial projection 44 engages into a recess 45 of the threaded nut 26.

FIG. 11 clearly shows the recess 45, which extends in the circumferential direction over a relatively large circumferential segment. In one circumferential direction, the recess 45 is delimited by a tooth 46 which is integrally formed on the threaded nut 26 and which is directed radially inward. It can also be seen from FIG. 11 that the projection 44 is arranged in a stop position in which it abuts against a first stop surface 47 of the tooth 46.

In the axial direction, the recess 45 is delimited by a base 54 formed in one piece with the threaded nut 26. The recess is delimited in the radial direction by a circumferential wall 55 formed in one piece with the threaded nut 26.

Said stop 43 prevents the threaded nut 26 from being able to be clamped axially to the support disk 33. This is because, before end surfaces, which face toward one another, of the threaded nut 26 and of the support disk 33 come into contact with one another, the projection 44 abuts against the first stop surface 47 of the tooth 46.

The recess 45 extends over a circumferential angle of greater than 180°, such that the projection 44, upon a screw-type relative rotation with respect to the threaded nut 26, protrudes into said recess 45.

The circumferential stop 43 is designed such that, in the stop situation, a minimum spacing a is maintained between the threaded nut 26 and the support disk 33, such that at any rate axial clamping between the threaded nut 26 and threaded spindle 28 is prevented. FIG. 10 denotes the minimum spacing a which is provided between the two end surfaces, which face toward one another, of the threaded nut 26 and of the spindle disk 33.

In particular, it can be seen from FIG. 10 that the projection 44 and the first stop surface 47 overlap one another in the axial direction. Said axial overlap is on the one hand smaller than the overall axial extent of the axial projection 44, such that in any case, the abovementioned minimum spacing a is ensured. On the other hand, said axial overlap is larger than the axial extent of the projection 44 minus the axial minimum spacing a between the stop 43 and the threaded nut 26. Furthermore, the axial extent of the projection 44 is at most as large as the pitch of the ball screw in order to keep the bending moments acting on the projection 44 low at the instant of abutment against the first stop surface 47.

To prevent radial forces being generated owing to the abutment in the stop situation, in the stop position, a second stop surface 48 formed on the projection 44 and the associated first stop surface 47 of the tooth 46 are arranged in a common plane which contains the spindle axis.

The recess 45, which in the exemplary embodiment is formed on the end side of the threaded nut 26, extends in the circumferential direction over an angle formed from a quotient of the ratio of the abovementioned axial overlap to the pitch of the threaded spindle, multiplied by 360°, wherein to determine the angle, the axial overlap and the pitch of the threaded spindle are both designated using the same unit of length.

It can also be seen from FIG. 10 that in each case one optical marking 49, 50 is formed on the threaded nut 26 and on the support disk 33. Here, said markings 49, 50 are small depressions formed on the outer circumference. Said markings 49, 50 permit simple assembly of the ball screw 24, as will be explained in more detail below.

For correct functioning of the stop 43, the rotational position of the support disk 33 with respect to the threaded spindle 28 is of significance. For example, if, in the exemplary embodiment, the support disk 33 were arranged rotated counterclockwise about the threaded spindle by 90°, a situation could arise in which the threaded nut 26 and the support disk 33 abut against one another at the end side before the stop 43 has taken effect in the circumferential direction. Accordingly, correct rotational positioning of a stop part 51 with respect to the threaded spindle 28 is of significance. In the exemplary embodiment, the stop part 51 is formed by the support disk 33.

It can be seen from FIG. 11 that the toothing 34, already mentioned further above, between the support disk 33 and the spindle portion 29 of the threaded spindle 28 is provided for transmitting torques. Said toothing 34 allows the support disk 33 to be placed onto the spindle portion 29 in a plurality of rotational positions. Said toothing 34 is formed here by an external toothing 52 on the outer circumference of the spindle portion 29 and by an internal toothing 53 on the inner circumference of the support disk 33.

A tooth flank angle α of the external toothing 52 or of the internal toothing 53 is designed to be as small as possible, such that the steepest possible tooth flanks are formed. Steep tooth flanks facilitate the tilting mobility, described further above, of the support disk 33 with respect to the threaded spindle 28. The finer the toothing, the more rotational positions can be set.

For assembly of the ball screw 24, the threaded nut 26 may firstly be screwed onto the threaded spindle 28 until the threaded nut 26 has reached its intended stop position. The support disk 33 may then be placed onto the spindle portion 29 and rotated relative to the threaded spindle 28 and the threaded nut 26 until the two markings 49, 50 are arranged in alignment with one another. The support disk 33 may then be pushed axially further in the direction of the threaded nut 26, wherein the internal toothing 53 engages into the external toothing 52. It is also conceivable for two markings to be provided for example on the support disk 33, between which the marking 49 of the threaded nut 26 should be arranged. In this way, an angle is defined within which an admissible rotational position for the support disk 33 relative to the threaded spindle 28 is provided.

The assembly depicted here may take place in an automated fashion, wherein the markings 49, 50 can be detected by means of suitable measurement sensors. When said markings 49, 50 are in alignment with one another, by means of suitable control, the next assembly step can be triggered and the support disk 33 can be pushed with its internal toothing 53 onto the external toothing 52 of the spindle portion 29.

The ball screw may be formed without a ball return facility. This means that the balls are arranged in a non-endless ball channel and can merely roll back and forth between the ends of said ball channel. In the exemplary embodiment, a helical compression spring may be inserted into the ball channel, one end of which spring is supported against the tooth 46 and the other end of which spring is loaded against the final ball. During load-free ball screw operation, all the balls can be spring-loaded in the direction of the end of the ball channel under the action of a spring force of the helical compression spring. Alternatively, a ball screw may also be used which has, as is known, a ball return facility: the balls circulate in a continuous manner in endless ball channels. The ball channel is formed from a load portion, in which the balls roll under load on ball grooves of the threaded nut and of the threaded spindle, and a return portion, in which the balls are returned from an end to a beginning of the load portion. The return portion may be formed, in a known way, by a diverting pipe on the outer circumference of the threaded nut, or else by diverting pieces which are inserted in the wall of the threaded nut. Said diverting pieces connect an end of a common winding of the load portion to the beginning thereof.

In the exemplary embodiment, the threaded nut 26 with the recess 45 and the tooth 46 is formed from a case-hardened steel in the semi-hot state. Semi-hot forming is carried out in a temperature range from 750° C. to 950° C. For semi-hot forming, prefabricated untreated parts may be inductively heated and formed on partially multi-stage presses.

Here, the ball groove is produced in a cutting process by turning. Alternatively or in addition, the ball groove may also be produced by thread rolling. The finished threaded nut is subsequently case-hardened.

The support disk 33 is likewise produced in a non-cutting process, in particular in the semi-hot forming process. It can be seen in particular from FIG. 9 that the axial projection is approximately half pushed through. This means that material of the support disk 33 is formed out of the disk-shaped part, wherein the support disk 33 is provided, on its end side facing away from the projection, with a cavity.

### LIST OF REFERENCE SYMBOLS

1 Brake device
2 Brake disk
3 Brake caliper
4 Brake pad
5 Brake pad
6 Housing-like portion
7 Ball screw
8 Threaded spindle
9 Balls
10 Threaded nut
11 Ball return element
12 Radial bearing
13 Axial bearing
14 Piston
15 Conical guide surface
16 Guide surface
17 Wall
18 First bearing disk
19 Second bearing disk
20 Needle rolling bodies
21 Axial projection
22 Second bearing surface
23 First bearing surface
24 Ball screw
25 Axial bearing
26 Threaded nut
27 Ball
28 Threaded spindle
29 Spindle portion
30 Polygon
31 Shoulder
32 First bearing surface
33 Support disk
34 Toothing
35 Conical opening
36 Second bearing surface
37 Contact path
38 Axial rolling bearing
39 Roller
40 Bearing disk
41 Bearing disk
42 Pocket
43 Stop
44 Projection
45 Recess
46 Tooth
47 First stop surface
48 Second stop surface
49 Marking
50 Marking
51 Stop part
52 External toothing
53 Internal toothing
54 Base
55 Circumferential wall
A Common axis
A₁ Axis of the brake caliper
A₂ Axis of the ball screw
A₃ Axis of the piston
R1 Radius of curvature of the first bearing surface
R2 Radius of the contact path
S Spindle axis

1. A ball screw comprising a threaded nut which is arranged on a threaded spindle and having a stop for circumferential abutment of the threaded nut in a stop position, wherein the stop has a first stop surface assigned to the threaded nut and has a second stop surface which is provided for abutting against the first stop surface and which is assigned to the threaded spindle, and in the stop position, an axial overlap of the first stop surface with the second stop surface is provided, and the axial overlap amounts to between 20% and 85% of a pitch of the threaded spindle.

2. The ball screw as claimed in claim 1, wherein the second stop surface is formed on an axial projection of a stop part arranged on the threaded spindle, wherein the axial overlap is formed from an axial extent of the projection minus an axial minimum spacing between the stop and the threaded nut.

3. The ball screw as claimed in claim 2, wherein the minimum spacing in the stop position is between 3/10 mm and 1 mm.

4. The ball screw as claimed in claim 2, wherein an axial extent of the projection is at most as large as the pitch of the threaded spindle.

5. The ball screw as claimed in claim 2, wherein the threaded nut is provided, on an end side facing thereof toward the stop, with a recess for the projection, which recess is open at the end side.

6. The ball screw as claimed in claim 1, wherein, in the stop position, the first stop surface and the second stop surface are arranged at least substantially in a common plane which contains an axis of the threaded spindle.

7. The ball screw as claimed in claim 5, wherein the recess extends in a circumferential direction at least over an angle formed from a quotient of a ratio of the axial overlap to the pitch of the threaded spindle, multiplied by 360 degrees, wherein the axial overlap and the pitch of the threaded spindle are both designated using a same unit of length.
